(19) United States
(12) Patent Application Publication
(10) Pub. No.: US 2014/0294210 A1
(43) Pub. Date: Oct. 2, 2014

(54) SYSTEMS, METHODS, AND APPARATUS FOR DIRECTING SOUND IN A VEHICLE

(71) Applicants: Jennifer Healey, San Jose, CA (US); David L. Graumann, Portland, OR (US)

(72) Inventors: Jennifer Healey, San Jose, CA (US); David L. Graumann, Portland, OR (US)

(21) Appl. No.: 13/977,572

(22) PCT Filed: Dec. 29, 2011
(86) PCT No.: PCT/US2011/067840

§ 371 Date: Mar. 19, 2014

(51) Int. Cl. H04S 7/00

(52) U.S. Cl. CPC H04S 7/303
USPC 381/302

(57) ABSTRACT

Certain embodiments of the invention may include systems, methods, and apparatus for directing sound in a vehicle. According to an example embodiment of the invention, a method is provided for steering sound within a vehicle. The method includes receiving one or more images from at least one camera attached to the vehicle; locating, from the one or more images, one or more body features associated with one or more occupants of the vehicle; generating at least one signal for controlling one or more sound transducers; and routing, based at least on the locating, the one or more generated signals to the one or more sound transducers for directing sound waves to at least one of the one or more body features.

### FIELD OF THE INVENTION

The invention generally relates to sound audio processing, and more particularly, to systems, methods, and apparatus for directing sound in a vehicle.

### BACKGROUND OF THE INVENTION

The terms “multi-channel audio” or “surround sound” generally refer to systems that can produce sounds that appear to originate from a number of different directions around a listener. The conventional and commercially available systems and techniques, including Dolby Digital, DTS, and Sony Dynamic Digital Sound (SDDS), are generally utilized for producing directional sounds in a controlled listening environment using pre-recorded and/or encoded multi-channel audio. Providing realistic directional audio in a vehicle cabin can present several challenges due to, among other things, close reflecting surfaces, limited space, and variations in physical attributes of the occupants.

### BRIEF DESCRIPTION OF THE FIGURES

Reference will now be made to the accompanying figures and flow diagrams, which are not necessarily drawn to scale, and wherein:

FIG. 1 is a block diagram of an illustrative vehicle audio system, according to an example embodiment of the invention.

FIG. 2 is an illustrative example speaker arrangement in a vehicle, according to an example embodiment of the invention.

FIG. 3 is a diagram of an illustrative directional sound field, according to an example embodiment of the invention.

FIG. 4 is a diagram of illustrative sound direction placements, according to an example embodiment of the invention.

FIG. 5 is a block diagram of an example audio and image processing system, according to an example embodiment of the invention.

FIG. 6 is a flow diagram of an example method, according to an example embodiment of the invention.

### DETAILED DESCRIPTION

Embodiments of the invention will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the following description, numerous specific details are set forth. However, it is understood that embodiments of the invention may be practiced without these specific details. In other instances, well-known methods, structures, and techniques have not been shown in detail in order not to obscure an understanding of this description. References to “one embodiment,” “an embodiment,” “example embodiment,” “various embodiments,” etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Embodiments of the invention will now be described more fully hereinafter with reference to the accompanying drawings. This invention may, however, be embodied in many different forms and should not be construed as limited to the embodiments set forth herein; rather, these embodiments are provided so that this disclosure will be thorough and complete, and will convey the scope of the invention.

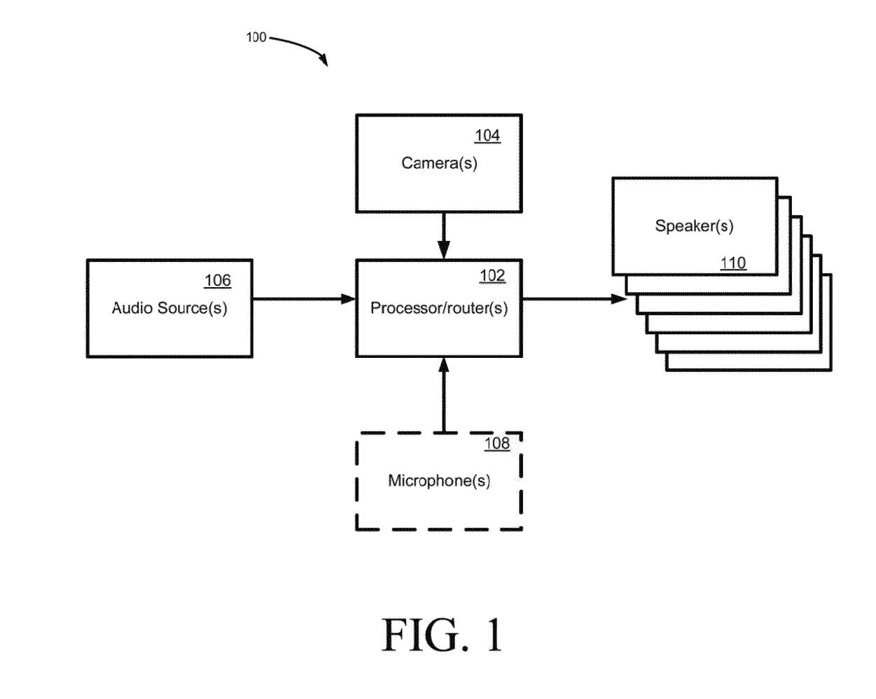

FIG. 1 depicts an example vehicle audio system 100 in accordance with an embodiment of invention. In an example embodiment, a processor/router 102 may be utilized to accept and process audio from an audio source 106, which may include, for example, stereo audio from a standard automobile radio, CD player, tape deck, or other hi-fi stereo source; a mono audio source, or a digitized multi-channel source, such as Dolby 5.1 surround sound; and/or audio from a communications device including a cell phone, navigation system, etc. According to an example embodiment, the processor/router 102 may also accept and process images from one or more cameras 104. According to an example embodiment, the processor/router 102 may also accept and process signals received from one or more microphones attached to the vehicle.

According to an example embodiment, the processor/router 102 may provide processing, routing, splitting, filtering, converting, compressing, limiting, amplifying, attenuating, delaying, panning, phasing, mixing, sending, bypassing, etc., to produce, or reproduce selectively directional sounds in a vehicle based at least in part on image information captured by the one or more cameras 104 and/or signal information from the one or more microphones 108. According to an example embodiment, video images may be analyzed by the processor/router 102, either in real-time or near real time, to extract spatial information that may be encoded or otherwise used for setting the parameters of the signals that may be sent to the speakers 110, or to other external gear for further processing. In an example embodiment of the invention, the apparent directionality of the sound information may be encoded and/or produced in relation to the position of objects or occupants via information extracted from the images obtained by one or more cameras 104.

According to an example embodiment, the sound localization may be automatically generated based at least in part on the processing and analysis of video information, which may include relative depth information as well as information related to the physical characteristics or position of one or more occupants of the vehicle. According to other embodiments of the invention, object or occupant position information may be processed by the processor/router 102 for dynamic positioning and/or placement of multiple sounds within the vehicle.

According to an example embodiment, an array of one or more speakers 110 may be in communication with the processor/router 102, and may be responsive to the signals produced by the processor/router 102. In one embodiment, the system 100 may also include one or more microphones 108 for detecting sound simultaneously from one or more directions outside of the vehicle.

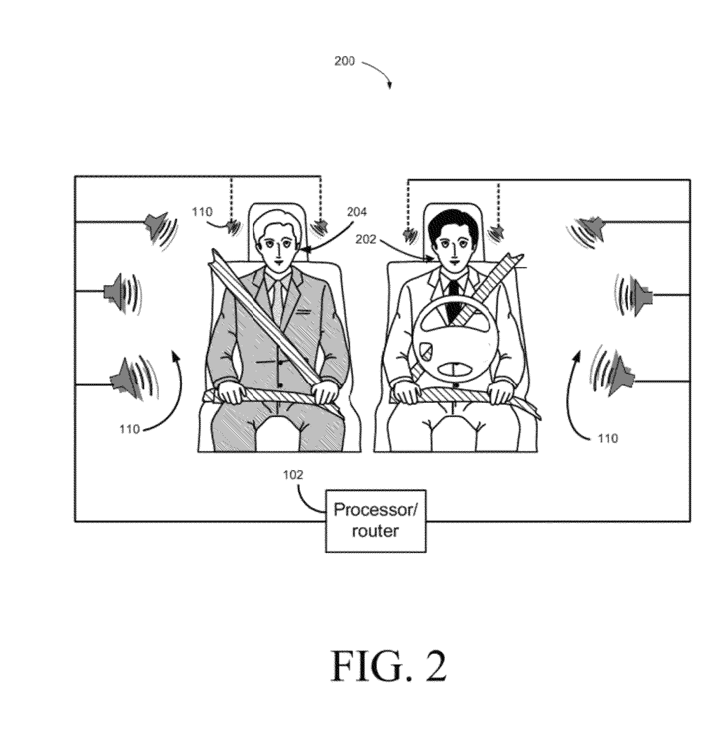

FIG. 2 is an illustrative example speaker arrangement in a vehicle with occupants 202, 204, according to an example embodiment of the invention. In an example embodiment, the speakers 110, in communication with the processor/router 102, can be arranged within a vehicle cabin, for example, in the doors, headrests, console, roof, etc. According to other example embodiments, the number and physical layout of speakers 110 can vary within the vehicle.

According to example embodiments, the vehicle cabin may include various surfaces that may interact with sound in different ways. For example, seats may include an acoustically absorbing material, while windows and dash panels may reflect sound. In example embodiments, the position, shape, and acoustic properties of the various vehicle components, items, and/or occupants 202, 204 in a vehicle may be modeled to provide, for example, transfer functions for determining the direction, divergence, reflections, and delays associated with sound from each of the speakers 110.

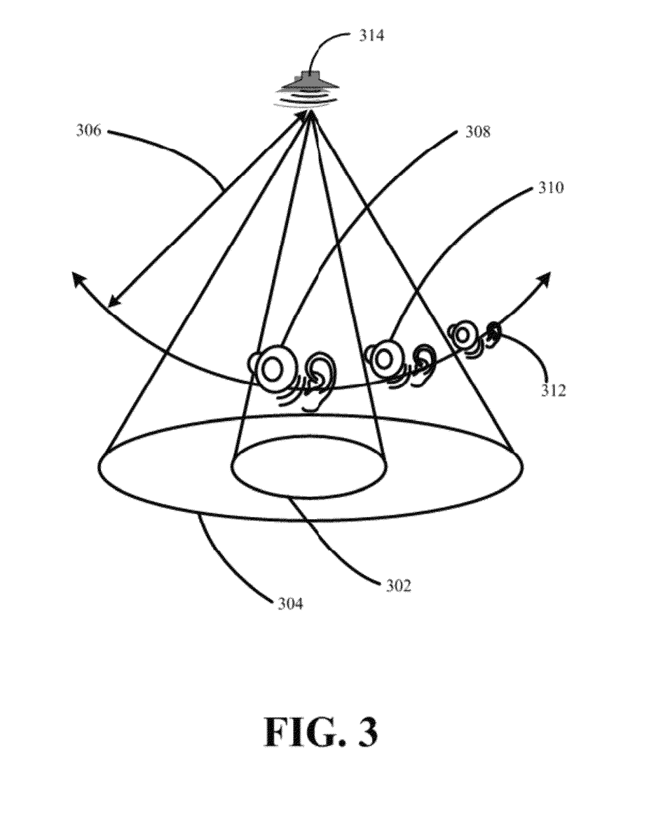

FIG. 3 is a diagram of an illustrative directional sound field emanating from a sound source 314 and comprising sound cones 302, 304, according to an example embodiment of the invention. According to an example embodiment, an outer boundary of the first sound cone 302 may represent the −3 dB sound pressure level (SPL) position relative to the maximum SPL, which may reside near the center of the first sound cone 302. According to an example embodiment, the outer boundary of the second sound cone 304 may correspond roughly to a −6 dB SPL position relative to the maximum SPL. According to an example embodiment, the effective diameter of the respective sound cones 302, 304 in the plane of the occupant's ear 312 may be a function of sound frequency and distance 306 from the sound source 314 to the occupant's ear 312. According to example embodiments, an occupant's ear 312 may be near the center of the first sound cone 302 where the SPL is greatest. The perceived volume 308 within the first sound cone 302 may, for example, be approximately 3 dB louder than the perceived volume 310 in the region just outside of the first sound cone 302, but within the second sound cone 304. FIG. 3 depicts an example of the diminishing perceived volume of sound as the occupant's ear 312 moves relative to the direction of the sound field.

According to example embodiment, the occupant's ear 312 may move relative to the directional sound field, or the directional sound field may be steered relative to the occupant's ear 312. For example, the sound source may be steered by introducing a phase shift in signals feeding two or more speakers. According to an example embodiment, the position of the occupant's ear 312 may be tracked with a camera, and the directional sound field may be selectively steered. For example the sound field may be steered towards the occupant's ear 312 to provide a relatively louder (or isolated) audible signal for that particular occupant compared with other occupants in the vehicle.

In accordance with example embodiments, the frequency content of the sound field may be adjusted to control the diameter of the sound cone or to enhance the directionality of the sound field. It is known that sounds having low frequency content, for example, in the 20 Hz to 500 Hz range, may appear to be omni-directional due to the longer wavelengths. For example, a 20 Hz tone has a wavelength of approximately 17 meters. A 500 Hz tone has a wavelength of approximately 70 cm. According to an example embodiment, selectively directing sounds may be enabled by selectively applying low pass filters to audio signals so that the frequencies below about 1700 Hz are removed (resulting in sounds having wavelengths of about 20 cm or less). According to example embodiments, the frequency content of the resulting sounds may be selectively adjusted to filter out a larger range of low frequencies to give a smaller diameter sound cone 302, and to provide more audible isolation between, for example, a driver and a passenger. According to some example embodiments, frequencies below about 3000 Hz may be filtered out to provide even more isolation.

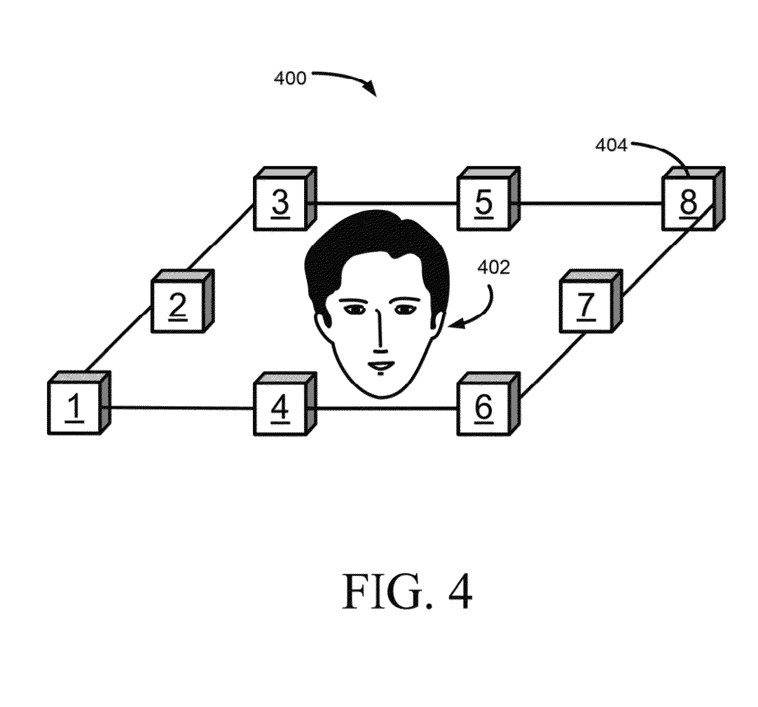

FIG. 4 depicts illustrative sound direction placements 400, according to an example embodiment of the invention. The various positions 404 depicted and associated with the sound direction placements 400 may serve as an aid for describing, in space, the relative placement of sound localizations relative to a head 402 of an occupant. According to an example embodiment, the sound direction placements 400 may be centered on the head 402 of an occupant. For example, the occupant facing the front of a vehicle may face sub-region position 4. According to other embodiments, the various positions 404, for example, positions marked 1 through 8 may include more or less sub-regions. However, for the purposes of defining general directions, vectors, localization, etc., of the directional sound field information, the sound direction placements 400 may provide a convenient framework for understanding embodiments of the invention.

According to an example embodiment, one aspect of the invention is to adjust, in real or near-real time, signals being sent to multiple speakers, so that all or part of the sound is dynamically localized to a particular region in space and is, therefore, perceived to be coming from a particular direction.

According to an example embodiment, the various positions 404 depicted in FIG. 4 may represent placement of microphones (for example, the microphones 108 as shown in FIG. 1). According to an example embodiment, the microphones may be placed around the exterior of the vehicle and may be used, for example, to localize the direction of sounds external to the vehicle. According to example embodiments, sounds originating outside of the vehicle may be tracked to determine a predominant direction of the external sound. According to an example embodiment, the external sound may be reproduced within the vehicle to provide a corresponding in-vehicle sound field, as if it were originating from the corresponding predominant direction of the external sound, for example, to provide enhanced sensing of the direction of the external sound. It is often difficult to tell which direction an emergency vehicle is traveling by the sound of its siren, and example embodiments of the invention may provide additional clues as to the direction of such external sounds. In an example scenario, a driver of a vehicle may not be able to see a car in his/her blind spot. Example embodiments of the invention may utilize multiple microphones or other sensors in combination with speakers within the vehicle to provide an audible indication of the direction and distance to another vehicle or object.

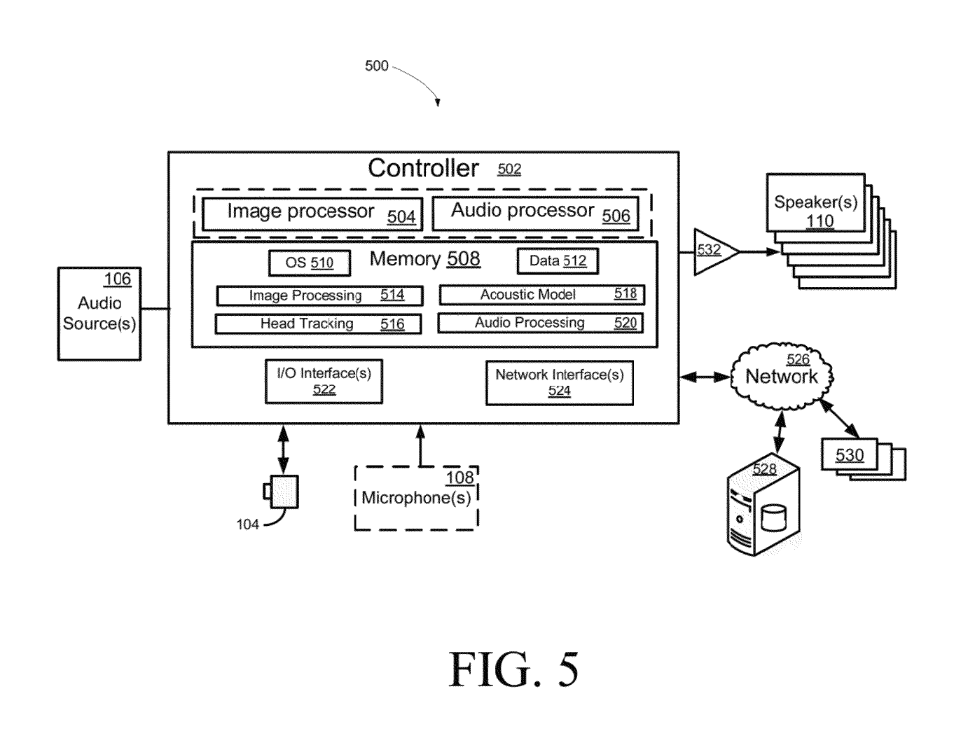

FIG. 5 is block diagram of an example audio and image processing system 500 that includes a controller 502 for receiving, processing, and outputting signals. According to an example embodiment, one or more input/output interfaces 522 may be utilized for receiving inputs from one or more audio sources 106 and one or more cameras 104. According to an example embodiment, the one or more input/output interfaces 522 may be utilized for receiving inputs from one or more microphones 108, as was discussed with reference to FIG. 4.

According to an example embodiment, the audio source(s) 106 may be in communication with an audio processor 506, and the camera 104 may be in communication with an image processor 504. According to an example embodiment, the image processor 504 and the audio processor 506 may be the same microprocessor. In either case, each of the processors 504, 506 may be in communication with a memory device 508.

In an example embodiment, the memory 508 may include an operating system 510. According to an example embodiment, the memory 508 may be used for storing data 512. In an example embodiment, the memory 508 may include several machine-readable code modules for working in conjunction with the processor(s) 504, 506 to perform various processes related to audio and/or image processing. For example, an image-processing module 514 may be utilized for performing various functions related to images. For example, image-processing module 514 may receive images from the camera 104 and may isolate a region of interest (ROI) associated with the image. In an example embodiment, the image-processing module 514 may be utilized to analyze the incoming image stream and may provide focus and/or aperture control for the camera 104.

In accordance with an example embodiment, the memory 508 may include a head-tracking module 516 that may work in conjunction with the image-processing module 514 to locate and track certain features associated with the images, and this tracking information may be utilized for directing audio. According to an example embodiment, the tracking module 516 may be utilized to continuously track the head or other body parts of the occupant, and the sound may be selectively directed to the occupant's ears based, at least in part, on the tracking as the occupant moves his/her head or torso. In another example embodiment, the tracking module 516 may be set up so that the sound cones (or predominant direction of the sound) may be initially setup then fixed, allowing the person to intentionally move in and out of the sound cones. In an example embodiment, one or more cameras 104 may be utilized to capture images of a vehicle occupant, particularly the head portion of the occupant. According to an example embodiment, portions of the head and upper body of the occupant may be analyzed to determine or estimate a head transfer function that may be utilized for altering the audio output. For example, the position, tilt, attitude, etc. associated with an occupant's head, ears, etc., may be tracked by processing the images from the camera 104 and by identifying and isolating regions of interest. According to an example embodiment, the head-tracking module 516 may provide real-time, or near real-time information as to the position of the vehicle occupant's head so that proper audio processes can be performed, as will now be described with reference to the acoustic model module 518 and the audio processing module 520.

According to example embodiments, the acoustic model module 518 may include acoustic modeling information pertaining to structures, materials, and placement of objects in the vehicle. For example, the acoustic model module 518 may take into account reflective surfaces within the vehicle, and may provide, for example, information regarding the sound pressure level transfer function from a sounds source (such as a speaker) to locations within the vehicle that may correspond to an occupant's head or ear. According to an example embodiment, the acoustic model module 518 may further take into account the sound field beam width, reflections, and scatter based on frequency content, and may be utilized for adjusting the filtering of the audio signal.

According to an example embodiment, the memory 508 may also include an audio processing module 520. In accordance with an example embodiment, the audio processing module 520 may work in conjunction with the head-tracking module 516 and the acoustic model 518 to provide, for example, routing, frequency filter, phasing, loudness, etc., of one or more audio channels to selectively direct sound to a particular predominant position within the vehicle. For example, the audio processing module 520 may modify the steering of a sound field within the vehicle based on the position of an occupant's head, as determined from the camera 104 and the head-tracking module 516. According to an example embodiment, the audio processing module 520 may confine sound cones of particular audio to a particular occupant of the vehicle. For example, multiple people may be in a vehicle, each with their own music listening preferences. According to an example embodiment, the audio processing module 520 may direct particular audio information to the driver, while one or more of the passengers may be receiving a completely different audio signal.

According to an example embodiment, the audio processing module 520 may also be used for placing sounds within the vehicle that correspond to directions of sounds external to the vehicle that may be sensed by the one or more microphones 108.

According to an example embodiment, the controller 502 may include processing capability for splitting and routing audio signals. According to an example embodiment, audio signals can include analog signals and/or digital signals. According to an example embodiment, the controller 502 may include multi-channel leveling amplifiers for processing inputs from multiple microphones 108 or other audio sources 106. The multi-channel leveling amplifiers may be in communication with multi-channel filters or crossovers for further splitting out signals by frequency for particular routing. In an example embodiment, the controller may include multi-channel delay or phasing capability for selectively altering the phase of signals. According to an example embodiment, the system 500 may include multi-channel output amplifiers 532 for individually driving speakers 110 with tailored signals.

With continued reference to FIG. 5, and according to an example embodiment of the invention, a multi-signal bus with multiple summing/mixing/routing nodes may be utilized for routing, directing, summing, or mixing signals to and from any of the modules 514-520, and/or the multi-channel output amplifiers 532. According to an example embodiment of the invention, the audio processor 506 may include multi-channel leveling amplifiers that may be utilized to normalize the incoming audio channels, or to otherwise selectively boost or attenuate certain bus signals. According to an example embodiment, the audio processor 506 may also include a multi-channel filter/crossover module that may be utilized for selective equalization of the audio signals. According to an example embodiment, one function of the multi-channel filter/crossover may be to selectively alter the frequency content of certain audio channels so that, for example, only relatively mid and high frequency information is directed to the particular speakers 110, or so that only the low frequency content from all channels is directed to a subwoofer speaker.

With continued reference to FIG. 5, and according to an example embodiment, the audio processor 506 may include multi-channel delays that may receive signals from any of the other modules 514-520 in any combination via a parallel audio bus and summing/mixing/routing nodes or by the input splitter router. The multi-channel delays may be operable to impart a variable delay to the individual channels of audio that may ultimately be sent to the speakers. The multi-channel delays may also include a sub-module that may impart phase delays, for example, to selectively add constructive or destructive interference within the vehicle, or to adjust the size and position of a sound field cone.

According to an example embodiment, the audio and image processing system 500 may be configured to communicate wirelessly via a network 526 to a remote server 528 and/or to remote services 530. For example, firmware updates for the controller and other associated devices may be handled via the wireless network connection and via one or more network interfaces 524.

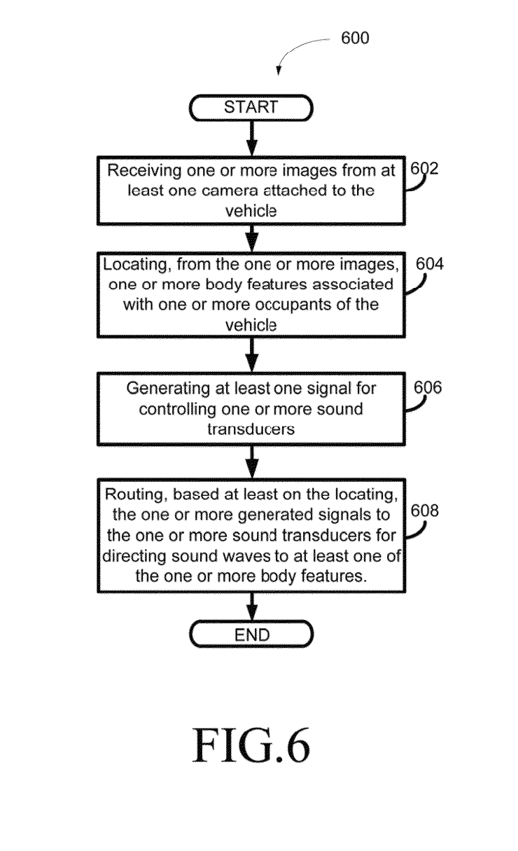

An example method 600 for steering sound within a vehicle will now be described with reference to the flow diagram of FIG. 6. The method 600 starts in block 602, and according to an example embodiment of the invention includes receiving one or more images from at least one camera attached to the vehicle. In block 604, the method 600 includes locating, from the one or more images, one or more body features associated with one or more occupants of the vehicle. In block 606, the method 600 includes generating at least one signal for controlling one or more sound transducers. In block 608, the method 600 includes routing, based at least on the locating, the one or more generated signals to the one or more sound transducers for directing sound waves to at least one of the one or more body features. The method 600 ends after block 608.

According to example embodiments, certain technical effects can be provided, such as creating certain systems, methods, and apparatus that provide directed sound within a vehicle. Example embodiments of the invention can provide the further technical effects of providing systems, methods, and apparatus for reproducing, within the vehicle, sensed sounds that originate external to the vehicle for enhanced sensing of a direction of the external sounds.

In example embodiments of the invention, the audio and image processing system 500 may include any number of hardware and/or software applications that are executed to facilitate any of the operations. In example embodiments, one or more input/output interfaces may facilitate communication between the audio and image processing system 500 and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the audio and image processing system 500. The one or more input/output interfaces may be utilized to receive or collect data and/or user instructions from a wide variety of input devices. Received data may be processed by one or more computer processors as desired in various embodiments of the invention and/or stored in one or more memory devices.

One or more network interfaces may facilitate connection of the audio and image processing system 500 inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth™ (owned by Telefonaktiebolaget LM Ericsson) enabled network, a Wi-Fi™ (owned by Wi-Fi Alliance) enabled network, a satellite-based network, any wired network, any wireless network, etc., for communication with external devices and/or systems.

As desired, embodiments of the invention may include the audio and image processing system 500 with more or less of the components illustrated in FIG. 5.

Certain embodiments of the invention are described above with reference to block and flow diagrams of systems, methods, apparatus, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the invention have been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the invention, including the best mode, and also to enable any person skilled in the art to practice certain embodiments of the invention, including making and using any devices or systems and performing any incorporated methods. The patentable scope of certain embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The claimed invention is:

1. A method comprising executing computer-executable instructions by one or more processors for steering sound within a vehicle, the method further comprising:
receiving one or more images from at least one camera attached to the vehicle;
locating, from the one or more images, one or more body features associated with one or more occupants of the vehicle;
generating at least one signal for controlling one or more sound transducers; and
routing, based at least in part on the locating, the one or more generated signals to the one or more sound transducers for directing sound waves to at least one of the one or more body features.

2. The method of claim 1, wherein the locating of the one or more body features comprises locating at least a head.

3. The method of claim 1, wherein the locating of the one or more body features comprises locating at least an ear.

4. The method of claim 1, wherein routing the one or more generated signals comprises selectively routing the one or more generated signals to one or more speakers within the vehicle.

5. The method of claim 1, wherein directing sound waves comprises forming at least a first audio beam, wherein the first audio beam is predominantly localized to the one or more body features associated with a first occupant of the vehicle.

6. The method of claim 5, wherein directing sound waves further comprises forming a second audio beam, wherein the second audio beam is predominantly localized to the one or more body features associated with a second occupant of the vehicle.

7. The method of claim 1, further comprising sensing one or more of external sounds or external visible light and sensing an orientation of the one or more of the external sounds or the external visible light, wherein the one or more of the external sounds or the external visible light originate outside of the vehicle.

8. The method of claim 7, further comprising reproducing the sensed external sounds and selectively directing the reproduced external sounds from the one or more sound sources within the vehicle to mimic at least the sensed orientation of the external sounds relative to an orientation of the vehicle.

9. The method of claim 7, further comprising utilizing the external visible light and the external sounds to improve a sensing of an orientation of the external visible light and the external sounds relative to an orientation of the vehicle.

10. A vehicle comprising:
at least one camera attached to the vehicle;
one or more speakers attached to the vehicle;
at least one memory for storing data and computer-executable instructions; and
one or more processors configured to access the at least one memory and further configured to execute computer-executable instructions for:
receiving one or more images from the at least one camera;
locating, from the one or more images, one or more body features associated with one or more occupants of the vehicle;
generating at least one signal for controlling the one or more speakers; and
selectively routing, based at least in part on the locating, the one or more generated signals to the one or more speakers for directing sound waves to at least one of the one or more body features.

11. The vehicle of claim 10, wherein the locating of the one or more body features comprises locating at least a head.

12. The vehicle of claim 10, wherein the locating of the one or more body features comprises locating at least an ear.

13. The vehicle of claim 10, wherein directing sound waves comprises forming at least a first audio beam, wherein the first audio beam is predominantly localized to the one or more body features associated with a first occupant of the vehicle

14. The vehicle of claim 10, wherein directing sound waves further comprises forming a second audio beam, wherein the second audio beam is predominantly localized to the one or more body features associated with a second occupant of the vehicle.

15. The vehicle of claim 10, further comprising a plurality of microphones attached to the vehicle for sensing external sounds and sensing an orientation of the external sounds, wherein the external sounds originate outside of the vehicle.

16. The vehicle of claim 15, wherein the one or more processors are further configured for reproducing the sensed external sounds by selectively directing signals corresponding to the sensed external sounds to the one or more speakers to mimic at least the sensed orientation of the external sounds relative to an orientation of the vehicle.

17. An apparatus comprising:
at least one memory for storing data and computer-executable instructions; and
one or more processors configured to access the at least one memory and further configured to execute computer-executable instructions for:
receiving one or more images from at least one camera attached to a vehicle;
locating, from the one or more images, one or more body features associated with one or more occupants of the vehicle;
generating at least one signal for controlling one or more speakers attached to the vehicle; and
selectively routing, based at least in part on the locating, the one or more generated signals to the one or more speakers for directing sound waves to at least one of the one or more body features.

18. The apparatus of claim 17, wherein the locating of the one or more body features comprises locating at least a head of an occupant of the vehicle.

19. The apparatus of claim 17, wherein the locating of the one or more body features comprises locating at least an ear.

20. The apparatus of claim 17, wherein directing sound waves comprises forming at least a first audio beam, wherein the first audio beam is predominantly localized to the one or more body features associated with a first occupant of the vehicle.

21. The apparatus of claim 17, wherein directing sound waves further comprises forming a second audio beam, wherein the second audio beam is predominantly localized to the one or more body features associated with a second occupant of the vehicle.

22. The apparatus of claim 17, wherein the one or more processors are further configured for receiving microphone signals from a plurality of microphones attached to the vehicle for sensing external sounds and sensing an orientation of the external sounds, wherein the external sounds originate outside of the vehicle.

23. The apparatus of claim 22, wherein the one or more processors are further configured for reproducing the sensed external sounds by selectively directing signals corresponding to the sensed external sounds to the one or more speakers to mimic at least the sensed orientation of the external sounds relative to an orientation of the vehicle.

24. A computer program product, comprising a computer-usable medium having a computer-readable program code embodied therein, said computer-readable program code adapted to be executed to implement a method for steering sound within a vehicle, the method further comprising:
receiving one or more images from at least one camera attached to the vehicle;
locating, from the one or more images, one or more body features associated with one or more occupants of the vehicle;
generating at least one signal for controlling one or more sound transducers; and
routing, based at least in part on the locating, the one or more generated signals to the one or more sound transducers for directing sound waves to at least one of the one or more body features.

25. The computer program product of claim 24, wherein the locating of the one or more body features comprises locating at least a head.

26. The computer program product of claim 24, wherein the locating of the one or more body features comprises locating at least an ear.

27. The computer program product of claim 24, wherein routing the one or more generated signals comprises selectively routing the one or more generated signals to one or more speakers within the vehicle.

28. The computer program product of claim 24, wherein directing sound waves comprises forming at least a first audio beam, wherein the first audio beam is predominantly localized to the one or more body features associated with a first occupant of the vehicle

29. The computer program product of claim 24, further comprising sensing one or more of external sounds or external visible light and sensing an orientation of the one or more of the external sounds or the external visible light, wherein the external sounds and the external visible light originate outside of the vehicle.

30. The computer program product of claim 29, further comprising reproducing the sensed external sounds and selectively directing the reproduced external sounds from the one or more sound sources within the vehicle to mimic at least the sensed orientation of the external sounds relative to an orientation of the vehicle.
